(19) United States
(12) Patent Application Publication
(10) Pub. No.: US 2023/0198002 A1
(43) Pub. Date: Jun. 22, 2023

(54) SECONDARY BATTERY

(71) Applicant: MURATA MANUFACTURING CO., LTD., Kyoto (JP)

(72) Inventor: Takumi HIASA, Kyoto (JP)

(21) Appl. No.: 18/110,105

(22) Filed: Feb. 15, 2023

Related U.S. Application Data
(63) Continuation of application No. PCT/JP2021/027136, filed on Jul. 20, 2021.

(30) Foreign Application Priority Data
Sep. 10, 2020 (JP) 2020-151933

(51) Int. Cl. H01M 10/0525; H01M 50/497; H01M 10/0569

(52) U.S. Cl. CPC H01M 10/0525; H01M 50/497; H01M 10/0569; H01M 2004/027

(57) ABSTRACT

A secondary battery includes a partition, a positive electrode, a negative electrode, a positive electrode electrolytic solution, and a negative electrode electrolytic solution. The partition is disposed between a positive electrode space and a negative electrode space, and allows a metal ion to pass therethrough. The positive electrode is disposed in the positive electrode space and is an electrode which the metal ion is to be inserted into and extracted from. The negative electrode is disposed in the negative electrode space and is an electrode which the metal ion is to be inserted into and extracted from. The positive electrode electrolytic solution is contained in the positive electrode space and includes an aqueous solvent. The negative electrode electrolytic solution is contained in the negative electrode space and includes an aqueous solvent. The negative electrode electrolytic solution has a pH that is higher than a pH of the positive electrode electrolytic solution. The partition includes a cation exchange membrane that is ion exchanged with the metal ion.

### CROSS REFERENCE TO RELATED APPLICATIONS

The present application is a continuation of PCT patent application no. PCT/JP2021/027136, filed on Jul. 20, 2021, which claims priority to Japanese patent application no. JP2020-151933, filed on Sep. 10, 2020, the entire contents of which are herein incorporated by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. As such a secondary battery, a secondary battery including an electrolytic solution that includes an aqueous solvent, i.e., a so-called aqueous electrolytic solution, is being developed. A configuration of the secondary battery has been considered in various ways.

Specifically, in order to suppress degradation of a capacity of a lithium-ion secondary battery including an electrolytic solution that includes an organic solvent, a separator has a multilayer structure including an ion exchange resin layer, and the ion exchange resin layer includes a cation exchange resin that is ion exchanged in advance with a lithium ion. Further, in order for an aqueous solution-based storage battery in which an oxidation-reduction reaction proceeds with use of hydroxyl ions to achieve a high battery voltage and a large capacity, an ion-selective cation exchange membrane is used as a partition, and a negative electrode electrolytic solution is higher than a positive electrode electrolytic solution in pH.

### SUMMARY

The present technology relates to a secondary battery.

Although consideration has been given in various ways regarding a battery characteristic of a secondary battery including an aqueous electrolytic solution, a cyclability characteristic of the secondary battery is not sufficient yet. Accordingly, there is still room for improvement in terms thereof.

It is therefore desirable to provide a secondary battery that is able to achieve a superior cyclability characteristic.

A secondary battery according to an embodiment includes a partition, a positive electrode, a negative electrode, a positive electrode electrolytic solution, and a negative electrode electrolytic solution. The partition is disposed between a positive electrode space and a negative electrode space, and allows a metal ion to pass therethrough. The positive electrode is disposed in the positive electrode space and is an electrode which the metal ion is to be inserted into and extracted from. The negative electrode is disposed in the negative electrode space and is an electrode which the metal ion is to be inserted into and extracted from. The positive electrode electrolytic solution is contained in the positive electrode space and includes an aqueous solvent. The negative electrode electrolytic solution is contained in the negative electrode space and includes an aqueous solvent. The negative electrode electrolytic solution has a pH that is higher than a pH of the positive electrode electrolytic solution. The partition includes a cation exchange membrane that is ion exchanged with the metal ion.

According to the secondary battery of an embodiment, the positive electrode space has the positive electrode, which the metal ion is to be inserted into and extracted from, disposed therein and contains the positive electrode electrolytic solution including the aqueous solvent; the negative electrode space has the negative electrode, which the metal ion is to be inserted into and extracted from, disposed therein and contains the negative electrode electrolytic solution including the aqueous solvent; and the partition that allows the metal ion to pass therethrough is disposed between the positive electrode space and the negative electrode space. Further, the negative electrode electrolytic solution has the pH that is higher than the pH of the positive electrode electrolytic solution, and the partition includes the cation exchange membrane that is ion exchanged with the metal ion. Accordingly, it is possible to achieve a superior cyclability characteristic.

Note that effects of the present technology are not necessarily limited to those described herein and may include any of a series of effects in relation to the present technology.

### BRIEF DESCRIPTION OF THE FIGURES

FIG. 1 is a sectional view of a configuration of a secondary battery according to an embodiment of the present technology.

FIG. 2 is a sectional view of a configuration of a secondary battery according to an embodiment of the present technology.

FIG. 3 is a sectional view of a configuration of a secondary battery according to an embodiment of the present technology.

### DETAILED DESCRIPTION

One or embodiments of the present technology are described below in further detail including with reference to the drawings.

A description is given of a secondary battery according to an embodiment of the present technology.

A secondary battery to be described here is a secondary battery utilizing insertion and extraction of a metal ion. The secondary battery includes a positive electrode, a negative electrode, and an electrolytic solution that is a liquid electrolyte including an aqueous solvent, i.e., an aqueous electrolytic solution. The secondary battery utilizes insertion and extraction of the metal ion to allow charging and discharging reactions to proceed, thereby obtaining a battery capacity.

The metal ion to be inserted and extracted in the secondary battery is not limited to a particular kind. Specifically, the metal ion is a light metal ion such as an alkali metal ion or an alkaline earth metal ion. Specific examples of the alkali metal ion include a lithium ion, a sodium ion, and a potassium ion. Specific examples of the alkaline earth metal ion include a calcium ion, a strontium ion, and a barium ion. In particular, the metal ion is preferably the alkali metal ion. A reason for this is that the charging and discharging reactions proceed stably while a high voltage is obtained.

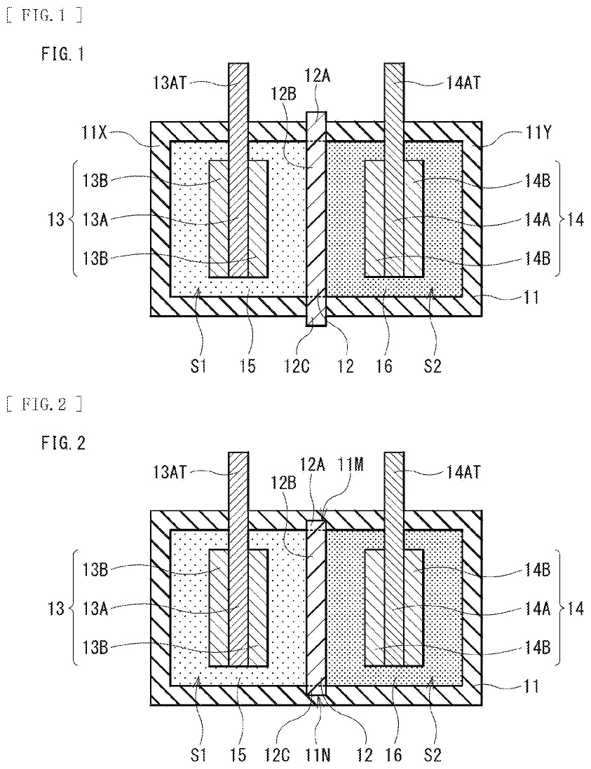

FIG. 1 illustrates a sectional configuration of a secondary battery. As illustrated in FIG. 1, the secondary battery includes an outer package member 11, a partition 12, a positive electrode 13, a negative electrode 14, a positive electrode electrolytic solution 15, and a negative electrode electrolytic solution 16. In FIG. 1, the positive electrode electrolytic solution 15 is lightly shaded and the negative electrode electrolytic solution 16 is darkly shaded.

The positive electrode electrolytic solution 15 and the negative electrode electrolytic solution 16 are each the aqueous electrolytic solution including the aqueous solvent described above. The aqueous electrolytic solution is a solution in which an ionic material ionizable in the aqueous solvent is dissolved or dispersed in the aqueous solvent.

In the following, a description is given of an example case where the metal ion to be inserted into and extracted from each of the positive electrode 13 and the negative electrode 14 is the alkali metal ion. In the following description, for convenience, an upper side in FIG. 1 represents an upper side of the secondary battery and a lower side in FIG. 1 represents a lower side of the secondary battery.

The outer package member 11 has an internal space for containing components including, without limitation, the partition 12, the positive electrode 13, the negative electrode 14, the positive electrode electrolytic solution 15, and the negative electrode electrolytic solution 16. Here, the outer package member 11 includes two parts, i.e., an outer package part 11X and an outer package part 11Y, that form the internal space. The outer package parts 11X and 11Y each have a handleless mug shape which has an open end part and a closed end part. The outer package parts 11X and 11Y are disposed in such a manner that the open end parts are opposed to each other with the partition 12 interposed therebetween, and are joined to each other with the partition 12 interposed therebetween. The internal space of the outer package member 11 described above is thus a space surrounded by the outer package parts 11X and 11Y.

The outer package member 11 includes one or more of materials including, without limitation, a metal material, a glass material, and a polymer compound. Specifically, the outer package member 11 may be, but not limited to, a rigid metal can, a rigid glass case, a rigid plastic case, a soft or flexible metal foil, or a soft or flexible polymer film. It is to be noted that a material included in the outer package part 11X and a material included in the outer package part 11Y may be the same as or different from each other.

The partition 12 is disposed between the positive electrode 13 and the negative electrode 14, and divides the internal space of the outer package member 11 into two spaces, i.e., a positive electrode compartment S1 serving as a positive electrode space and a negative electrode compartment S2 serving as a negative electrode space. In other words, the partition 12 is positioned between the positive electrode compartment S1 and the negative electrode compartment S2, and thus separates the positive electrode compartment S1 and the negative electrode compartment S2 from each other. Accordingly, the positive electrode 13 and the negative electrode 14 are opposed to each other with the partition 12 interposed therebetween, and are separated from each other with the partition 12 interposed therebetween.

The partition 12 does not allow an anion to pass therethrough and allows a substance such as the alkali metal ion (a cation) other than the anion, which is to be inserted into and extracted from each of the positive electrode 13 and the negative electrode 14, to pass therethrough, between the positive electrode compartment S1 and the negative electrode compartment S2. A reason for this is that this prevents mixing of the positive electrode electrolytic solution 15 and the negative electrode electrolytic solution 16 with each other. The partition 12 thus allows the alkali metal ion to pass therethrough from the positive electrode compartment S1 to the negative electrode compartment S2, and allows the alkali metal ion to pass therethrough from the negative electrode compartment S2 to the positive electrode compartment S1.

Here, the partition 12 protrudes from the outer package member 11 on the upper side and protrudes from the outer package member 11 on the lower side. Thus, the partition 12 is sandwiched between the outer package parts 11X and 11Y that are disposed on two respective sides, and is therefore held by the outer package parts 11X and 11Y. Further, the partition 12 includes an upper end part 12A, an intermediate part 12B, and a lower end part 12C. The upper end part 12A, the intermediate part 12B, and the lower end part 12C are joined to each other, in other words, they are integrated with each other. In FIG. 1, for easier understanding of a configuration of the partition 12, a border between the upper end part 12A and the intermediate part 12B is represented by a dashed line, and a border between the lower end part 12C and the intermediate part 12B is represented by another dashed line.

The upper end part 12A protrudes from the outer package member 11 on the upper side, and is thus a part exposed to an outside of the outer package member 11. As a result, the upper end part 12A is not sandwiched between the positive electrode compartment S1 and the negative electrode compartment S2, and is thus a part that is in contact with neither the positive electrode electrolytic solution 15 nor the negative electrode electrolytic solution 16, i.e., a non-contact part.

The lower end part 12C protrudes from the outer package member 11 on the lower side, and is thus a part exposed to the outside of the outer package member 11. As a result, as with the upper end part 12A, the lower end part 12C is not sandwiched between the positive electrode compartment S1 and the negative electrode compartment S2, and is thus a part that is in contact with neither the positive electrode electrolytic solution 15 nor the negative electrode electrolytic solution 16, i.e., a non-contact part.

The intermediate part 12B is disposed between the upper end part 12A and the lower end part 12C, and is thus a part positioned inside the outer package member. As a result, the intermediate part 12B is sandwiched between the positive electrode compartment S1 and the negative electrode compartment S2, and is thus a part that is in contact with each of the positive electrode electrolytic solution 15 and the negative electrode electrolytic solution 16, i.e., a contact part.

In particular, the partition 12 includes an ion exchange membrane. More specifically, the partition 12 includes a porous film (a cation exchange membrane) that allows the alkali metal ion (the cation), which is to be inserted into and extracted from each of the positive electrode 13 and the negative electrode 14, to pass therethrough. The cation exchange membrane is ion exchanged in advance with the alkali metal ion which is to be inserted into and extracted from each of the positive electrode 13 and the negative electrode 14.

In other words, the cation exchange membrane serving as the partition 12 includes negative ion groups (—X⁻) originally, and the negative ion groups are neutralized by hydrogen ions (H⁺). Thus, the cation exchange membrane includes ion exchange groups (—X⁻H⁺). The negative ion groups are not limited to particular kinds, and specific examples thereof include sulfonic acid groups (—S(═O)₂—O⁻) and carboxylic acid groups (—C(═O)—O⁻).

However, the cation exchange membrane serving as the partition 12 is ion exchanged in advance with the alkali metal ion (Mt, where M is an alkali metal element) which is to be inserted into and extracted from each of the positive electrode 13 and the negative electrode 14. Thus, all or most of the hydrogen ions are substituted with the alkali metal ions. Accordingly, the cation exchange membrane that has been ion exchanged includes the ion exchange groups (—X⁻M⁺), that is, alkali metal complexes (salts).

A reason why the partition 12 includes the cation exchange membrane is that this makes it easier for each of the aqueous solvent in the positive electrode electrolytic solution 15 and the aqueous solvent in the negative electrode electrolytic solution 16 to permeate into the partition 12, which improves ion conductive property inside the partition 12.

Further, a reason why the cation exchange membrane is ion exchanged in advance with the alkali metal ion which is to be inserted into and extracted from each of the positive electrode 13 and the negative electrode 14 is as follows. As compared with a case where the cation exchange membrane is not ion exchanged in advance with the alkali metal ion, this prevents a hydrogen ion from easily being eluted from the partition 12 into each of the positive electrode electrolytic solution 15 and the negative electrode electrolytic solution 16, and also prevents another metal ion, which is not to be inserted into and extracted from each of the positive electrode 13 and the negative electrode 14, from easily being eluted from the partition 12 into each of the positive electrode electrolytic solution 15 and the negative electrode electrolytic solution 16. Accordingly, respective pHs of the positive electrode electrolytic solution 15 and the negative electrode electrolytic solution 16 are prevented from varying easily, which makes it easier to maintain a high-and-low relationship between the pHs of the two electrolytic solutions to be described later. As a result, an electrode component material such as a positive electrode active material or a negative electrode active material to be described later is prevented from degrading easily, and an electrode component member such as a positive electrode current collector 13A or a negative electrode current collector 14A to be described later is prevented from corroding easily. Details of the reason described here will be described later.

Here, as described above, the partition 12 includes the upper end part 12A, the intermediate part 12B, and the lower end part 12C. Accordingly, the cation exchange membrane is ion exchanged in advance with the alkali metal ion not only in the intermediate part 12B, but also in each of the upper end part 12A and the lower end part 12C.

In the cation exchange membrane, a skeleton to which the ion exchange groups are bonded is not limited to a particular kind as long as the skeleton is a polymer compound to which the ion exchange groups are bondable. Specific examples of the polymer compounds include a perfluorohydrocarbon.

Here, in order to check whether the cation exchange membrane serving as the partition 12 is ion exchanged in advance with the alkali metal ion, the secondary battery is disassembled to thereby collect the partition 12, following which a state of not the intermediate part 12B but of the upper end part 12A, the lower end part 12C, or each of the upper end part 12A and the lower end part 12C may be examined, or in other words, whether ion exchange takes place in not the intermediate part 12B but in the upper end part 12A, the lower end part 12C, or each of the upper end part 12A and the lower end part 12C may be examined.

Specifically, the intermediate part 12B is sandwiched between the positive electrode compartment S1 and the negative electrode compartment S2 as described above, and is thus in contact with each of the positive electrode electrolytic solution 15 and the negative electrode electrolytic solution 16.

In this case, even if the cation exchange membrane serving as the partition 12 includes the ion exchange groups (—X⁻H⁺) originally (prior to fabrication of the secondary battery), the intermediate part 12B allows the alkali metal ion to pass therethrough when the secondary battery is used. Accordingly, in the cation exchange membrane collected from the used secondary battery, ions including, without limitation, the hydrogen ions included in the ion exchange groups may be substituted with the alkali metal ions. That is, in the intermediate part 12B, states of the ion exchange groups (i.e., whether the hydrogen ions still remain as in an initial state) may change after use of the secondary battery.

In a case of using the intermediate part 12B, the state of the cation exchange membrane, i.e., the states of the ion exchange groups, may thus be changed due to the use of the secondary battery. This makes it difficult to check afterward whether the cation exchange membrane is ion exchanged in advance with the alkali metal ion.

In contrast, as described above, the upper end part 12A is not sandwiched between the positive electrode compartment S1 and the negative electrode compartment S2, and is thus in contact with neither the positive electrode electrolytic solution 15 nor the negative electrode electrolytic solution 16.

In this case, if the cation exchange membrane serving as the partition 12 includes the ion exchange groups (—X⁻H⁺) originally, the alkali metal ion does not pass through the upper end part 12A even if the secondary battery is used. Accordingly, in the cation exchange membrane collected from the used secondary battery, the hydrogen ions included in the ion exchange groups are not substituted with the alkali metal ions. That is, in the upper end part 12A, the state of the ion exchange groups, i.e., whether the hydrogen ions still remain as in an initial state, is maintained unchanged even after the use of the secondary battery.

In other words, the cation exchange membrane serving as the partition 12 is ion exchanged in advance with the alkali metal ion, and thus, in the case where the cation exchange membrane includes the ion exchange groups (—X⁻M⁺), the state of the ion exchange groups (whether the cation exchange membrane is ion exchanged in advance with the alkali metal ion) is maintained independently of whether the secondary battery is used.

In the case of examining the upper end part 12A, the state of the cation exchange membrane, i.e., the states of the ion exchange groups, is therefore maintained even if the secondary battery is used, which makes it possible to check afterward whether the cation exchange membrane is ion exchanged in advance with the alkali metal ion.

What has been described here regarding the upper end part 12A is also similarly true for the lower end part 12C that is in contact with neither the positive electrode electrolytic solution 15 nor the negative electrode electrolytic solution 16. That is, also in the case of examining the lower end part 12C, as with the case of examining the upper end part 12A, it is possible to check afterward whether the cation exchange membrane is ion exchanged in advance with the alkali metal ion.

A specific procedure for examining whether the cation exchange membrane serving as the partition 12 (the upper end part 12A, the lower end part 12C, or each of the upper end part 12A and the lower end part 12C) is ion exchanged in advance with the alkali metal ion is as described below.

First, the partition 12 is collected from the secondary battery, following which the upper end part 12A, the lower end part 12C, or each of the upper end part 12A and the lower end part 12C (the cation exchange membrane) is retrieved from the partition 12. Thereafter, the cation exchange membrane is immersed in hydrochloric acid having a concentration of 1 mol/l (=1 mol/dm³), following which the cation exchange membrane is taken out from hydrochloric acid to thereby obtain hydrochloric acid (an immersion liquid) in which the cation exchange membrane has been immersed. Lastly, the immersion liquid is analyzed by an analysis method such as inductively coupled plasma (ICP) optical emission spectroscopy to thereby quantify the alkali metal ions included in the immersion liquid. Thus, it is possible to check whether the ion exchange groups are ion exchanged with the alkali metal ions in the cation exchange membrane. This makes it possible to examine whether the cation exchange membrane is ion exchanged in advance with the alkali metal ion.

The positive electrode 13 is disposed in the positive electrode compartment S1, and allows the alkali metal ion to be inserted thereinto and extracted therefrom. Here, the positive electrode 13 includes a positive electrode current collector 13A having two opposed surfaces, and a positive electrode active material layer 13B provided on each of the two opposed surfaces of the positive electrode current collector 13A. However, the positive electrode active material layer 13B may be provided only on one of the two opposed surfaces of the positive electrode current collector 13A.

Note that the positive electrode current collector 13A is omittable. Therefore, the positive electrode 13 may include only the positive electrode active material layer 13B.

The positive electrode current collector 13A includes one or more of electrically conductive materials including, without limitation, a metal material, a carbon material, and an electrically conductive ceramic material. Specific examples of the metal material include titanium, aluminum, and an alloy thereof. Specific examples of the electrically conductive ceramic material include indium tin oxide (ITO).

Here, the positive electrode active material layer 13B is not provided on a portion of the positive electrode current collector 13A, i.e., a coupling terminal part 13AT, and the coupling terminal part 13AT is led out of the outer package member 11.

In particular, the positive electrode current collector 13A preferably includes a material that is insoluble or sparingly soluble in and resistant to corrosion by the positive electrode electrolytic solution 15, and that has low reactivity to the positive electrode active material. Therefore, the positive electrode current collector 13A preferably includes any of the above-described metal materials. That is, the positive electrode current collector 13A preferably includes a material such as titanium, aluminum, or an alloy thereof. A reason for this is that degradation of the positive electrode current collector 13A is thereby suppressed even if the secondary battery is used.

The positive electrode current collector 13A may be an electric conductor having a surface covered with plating of one or more materials among the metal material, the carbon material, and the electrically conductive ceramic material described above. The electric conductor is not limited to a particular material as long as the material is electrically conductive.

The positive electrode active material layer 13B includes one or more of positive electrode active materials which the alkali metal ion is to be inserted into and extracted from. Note that the positive electrode active material layer 13B may further include a material such as a positive electrode binder or a positive electrode conductor.

The positive electrode active material which a lithium ion is to be inserted into and extracted from as the alkali metal ion includes, for example, a lithium-containing compound. The lithium-containing compound is not limited to a particular kind, and specific examples thereof include a lithium composite oxide and a lithium phosphoric acid compound. The lithium composite oxide is an oxide that includes lithium and one or more transition metal elements as constituent elements. The lithium phosphoric acid compound is a phosphoric acid compound that includes lithium and one or more transition metal elements as constituent elements. The transition metal elements are not limited to particular kinds, and specific examples thereof include nickel, cobalt, manganese, and iron.

Specific examples of the lithium composite oxide having a layered rock-salt crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂. Specific examples of the lithium composite oxide having a spinel crystal structure include LiMn₂O₄. Specific examples of the lithium phosphoric acid compound having an olivine crystal structure include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

The positive electrode active material which a sodium ion is to be inserted into and extracted from as the alkali metal ion includes, for example, a sodium-containing compound. The sodium-containing compound is not limited to a particular kind, and specific examples thereof include a Prussian blue analog represented by Formula (1).

NaₓK_{y}M1_{z}Fe(CN)₆·aH₂O (1)

where:
M1 is Mn, Zn, or both;
x, y, and z satisfy 0.5<x≤2, 0≤y≤0.5, and 0≤z≤2;
a is any value; and
y may satisfy 0.05≤y≤0.2.

Specific examples of the Prussian blue analog include Na₂MnFe(CN₆), Na_{1.42}K_{0.09}Mn_{1.13}Fe(CN)₆·3H₂O, and Na_{0.83}K_{0.12}Zn_{1.49}Fe(CN)₆·3.2H₂O.

The positive electrode active material which a potassium ion is to be inserted into and extracted from as the alkali metal ion includes, for example, a potassium-containing compound. Specific examples of the potassium-containing compound include K_{0.7}Fe_{0.6}Mn_{0.6}O₂, K_{0.6}MnO₂, K_{0.3}MnO₂, K_{0.31}CoO₂, KCrO₂, K_{0.6}CoO₂, K_{2/3}Mn_{2/3}Co_{1/3}Ni_{1/3}O₂, K_{2/3}Ni_{2/3}Te_{1/3}O₂, K_{2/3}Ni_{1/6}Co_{1/2}Te_{1/3}O₂, K_{2/3}Ni_{1/2}Mn_{1/6}Te_{1/3}O₂, K_{2/3}Ni_{1/2}Co_{1/6}Te_{1/3}O₂, K_{2/3}M_{1/3}Zn_{1/3}Te_{1/3}O₂, K_{2/3}Ni_{1/6}Mg_{1/2}Te_{1/3}O₂, K_{2/3}Ni_{1/2}Co_{1/6}Te_{1/3}O₂, K_{2/3}Ni_{1/3}Mg_{1/3}Te_{1/3}O₂, and K_{2/3}Ni_{1/3}Co_{1/3}Te_{1/3}O₂.

The positive electrode binder includes one or more of materials including, without limitation, a synthetic rubber and a polymer compound. Specific examples of the synthetic rubber include a styrene-butadiene-based rubber. Specific examples of the polymer compound include polyvinylidene difluoride and polyimide.

The positive electrode conductor includes one or more of electrically conductive materials including, without limitation, a carbon material. Specific examples of the carbon material include graphite, carbon black, acetylene black, and Ketjen black. Note that the electrically conductive material may be a material such as a metal material, an electrically conductive ceramic material, or an electrically conductive polymer.

The negative electrode 14 is disposed in the negative electrode compartment S2, and allows the alkali metal ion to be inserted thereinto and extracted therefrom. Here, the negative electrode 14 includes a negative electrode current collector 14A having two opposed surfaces, and a negative electrode active material layer 14B provided on each of the two opposed surfaces of the negative electrode current collector 14A. However, the negative electrode active material layer 14B may be provided only on one of the two opposed surfaces of the negative electrode current collector 14A.

Note that the negative electrode current collector 14A is omittable. Therefore, the negative electrode 14 may include only the negative electrode active material layer 14B.

The negative electrode current collector 14A includes one or more of electrically conductive materials including, without limitation, a metal material, a carbon material, and an electrically conductive ceramic material. Specific examples of the metal material include stainless steel (SUS), titanium, zinc, tin, lead, and an alloy thereof. The stainless steel may be highly corrosion-resistant stainless steel to which one or more of additive elements including, without limitation, niobium and molybdenum are added. Specifically, the stainless steel may be SUS444 to which molybdenum is added as an additive element. Details of the electrically conductive ceramic material are as described above.

Here, the negative electrode active material layer 14B is not provided on a portion of the negative electrode current collector 14A, i.e., a coupling terminal part 14AT, and the coupling terminal part 14AT is led out of the outer package member 11. A direction in which the coupling terminal part 14AT is led out is, for example, similar to a direction in which the coupling terminal part 13AT is led out.

In particular, the negative electrode current collector 14A preferably includes a material that is insoluble or sparingly soluble in and resistant to corrosion by the negative electrode electrolytic solution 16, and that has low reactivity to the negative electrode active material. Therefore, the negative electrode current collector 14A preferably includes any of the above-described metal materials. That is, the negative electrode current collector 14A preferably includes a material such as stainless steel, titanium, zinc, tin, lead, or an alloy thereof. A reason for this is that degradation of the negative electrode current collector 14A is thereby suppressed even if the secondary battery is used.

The negative electrode current collector 14A may be an electric conductor having a surface covered with plating of one or more materials among the metal material, the carbon material, and the electrically conductive ceramic material described above. The electric conductor is not limited to a particular material as long as the material is electrically conductive.

The negative electrode active material layer 14B includes one or more of negative electrode active materials which the alkali metal ion is to be inserted into and extracted from. Note that the negative electrode active material layer 14B may further include a material such as a negative electrode binder or a negative electrode conductor. Details of the negative electrode binder are similar to those of the positive electrode binder. Details of the negative electrode conductor are similar to those of the positive electrode conductor.

The negative electrode active material includes a titanium-containing compound, a niobium-containing compound, a vanadium-containing compound, an iron-containing compound, and a molybdenum-containing compound. A reason for this is that this allows the charging and discharging reactions to proceed smoothly and stably even in a case of using the positive electrode electrolytic solution 15 and the negative electrode electrolytic solution 16.

Examples of the titanium-containing compound include a titanium oxide, an alkali-metal-titanium composite oxide, a titanium phosphoric acid compound, an alkali metal titanium phosphoric acid compound, and a hydrogen titanium compound.

The titanium oxide includes a compound represented by Formula (2), i.e., titanium oxide of a bronze type, for example.

TiO_{w} (2)

where w satisfies 1.85≤w≤2.15.

The titanium oxide above includes one or more of titanium oxide (TiO₂) of an anatase type, titanium oxide (TiO₂) of a rutile type, or titanium oxide (TiO₂) of a brookite type. However, the titanium oxide may be a composite oxide including one or more of elements including, without limitation, phosphorus, vanadium, tin, copper, nickel, iron, and cobalt as one or more constituent elements together with titanium. Specific examples of such a composite oxide include TiO₂—P₂O₅, TiO₂—V₂O₅, TiO₂—P₂O₅—SnO₂, and TiO₂—P₂O₅-MeO, where Me is one or more of elements including, without limitation, Cu, Ni, Fe, and Co.

One kind of the alkali-metal-titanium composite oxide is a lithium-titanium composite oxide, examples of which include respective compounds represented by Formulae (3) to (5), i.e., lithium titanate of a ramsdellite type. M3 in Formula (3) is a metal element that is to be a divalent ion. M4 in Formula (4) is a metal element that is to be a trivalent ion. M5 in Formula (5) is a metal element that is to be a tetravalent ion.

Li[LiₓM3_{(1-3x)/2}Ti_{(3+x)/2}]O₄ (3)

where:
M3 is at least one of Mg, Ca, Cu, Zn, or Sr; and
x satisfies 0≤x≤⅓.

Li[Li_{y}M4_{1-3y}Ti_{1+2y}]O₄ (4)

where:
M4 is at least one of Al, Sc, Cr, Mn, Fe, Ge, or Y; and
y satisfies 0≤y≤⅓.

Li[Li_{1/3}M5_{z}Ti_{(5/3)-z}]O₄ (5)

where:
M5 is at least one of V, Zr, or Nb; and
z satisfies 0<z<⅔.

Specific examples of the lithium-titanium composite oxide represented by Formula (3) include Li_{3.75}Ti_{4.875}Mg_{0.375}O₁₂. Specific examples of the lithium-titanium composite oxide represented by Formula (4) include LiCrTiO₄. Specific examples of the lithium-titanium composite oxide represented by Formula (5) include Li₄Ti₅O₁₂ and Li₄Ti_{4.95}Nb_{0.05}O₁₂.

Another kind of the alkali-metal-titanium composite oxide is a potassium-titanium composite oxide, specific examples of which include K₂Ti₃O₇ and K₄Ti₅O₁₂.

Specific examples of the titanium phosphoric acid compound include titanium phosphate (TiP₂O₇). One kind of the alkali metal titanium phosphoric acid compound is a lithium titanium phosphoric acid compound, specific examples of which include LiTi₂(PO₄)₃. Another kind of the alkali metal titanium phosphoric acid compound is a sodium titanium phosphoric acid compound, specific examples of which include NaTi₂(PO₄)₃. Specific examples of the hydrogen titanium compound include H₂Ti₃O₇(3TiO₂·1H₂O), H₆Ti₁₂O₂₇(3TiO₂·0.75H₂O), H₂Ti₆O₁₃(3TiO₂·0.5H₂O), H₂Ti₇O₁₅(3TiO₂·0.43H₂O), and H₂Ti₁₂O₂₅(3TiO₂·0.25H₂O).

Examples of the niobium-containing compound include an alkali-metal-niobium composite oxide, a hydrogen niobium compound, and a titanium-niobium composite oxide. Note that a material belonging to the niobium-containing compound is excluded from the titanium-containing compound.

Specific examples of the alkali-metal-niobium composite oxide include LiNbO₂. Specific examples of the hydrogen niobium compound include H₄Nb₆O₁₇. Specific examples of the titanium-niobium composite oxide include TiNb₂O₇ and Ti₂Nb₁₀O₂₉. The titanium-niobium composite oxide may be intercalated with the alkali metal.

Examples of the vanadium-containing compound include a vanadium oxide and an alkali-metal-vanadium composite oxide. Note that a material belonging to the vanadium-containing compound is excluded from each of the titanium-containing compound and the niobium-containing compound.

Specific examples of the vanadium oxide include vanadium dioxide (VO₂). Specific examples of the alkali-metal-vanadium composite oxide include LiV₂O₄ and LiV₃O₈.

Examples of the iron-containing compound include iron hydroxide. Note that a material belonging to the iron-containing compound is excluded from each of the titanium-containing compound, the niobium-containing compound, and the vanadium-containing compound.

Specific examples of the iron hydroxide include iron oxyhydroxide (FeOOH). The iron oxyhydroxide may be α-iron oxyhydroxide, β-iron oxyhydroxide, γ-iron oxyhydroxide, δ-iron oxyhydroxide, or any two or more thereof.

Examples of the molybdenum-containing compound include a molybdenum oxide and a cobalt-molybdenum composite oxide. Note that a material belonging to the molybdenum-containing compound is excluded from each of the titanium-containing compound, the niobium-containing compound, the vanadium-containing compound, and the iron-containing compound.

Specific examples of the molybdenum oxide include molybdenum dioxide (MoO₂). Specific examples of the cobalt-molybdenum composite oxide include CoMoO₄.

The positive electrode electrolytic solution 15 is contained in the positive electrode compartment S1, and the negative electrode electrolytic solution 16 is contained in the negative electrode compartment S2. The positive electrode electrolytic solution 15 and the negative electrode electrolytic solution 16 are therefore separated from each other with the partition 12 interposed therebetween in such a manner as not to be mixed with each other.

Specifically, the positive electrode electrolytic solution 15 and the negative electrode electrolytic solution 16 each include the aqueous solvent and one or more of ionic materials that are ionizable in the aqueous solvent. The positive electrode electrolytic solution 15 further includes the alkali metal ion that is to be inserted into and extracted from each of the positive electrode 13 and the negative electrode 14, and the negative electrode electrolytic solution 16 further includes the alkali metal ion that is to be inserted into and extracted from each of the positive electrode 13 and the negative electrode 14.

The aqueous solvent is not limited to a particular kind, and specific examples thereof include pure water. The ionic material is not limited to a particular kind, and specifically includes one or more of materials including, without limitation, an acid, a base, and an electrolyte salt. Specific examples of the acid include carbonic acid, oxalic acid, nitric acid, sulfuric acid, hydrochloric acid, acetic acid, and citric acid.

The electrolyte salt is a salt including a cation and an anion. More specifically, the electrolyte salt includes one or more of metal salts. The metal salts are not limited to particular kinds, and specific examples thereof include an alkali metal salt, an alkaline earth metal salt, and a transition metal salt.

Examples of the alkali metal salt include a lithium salt, a sodium salt, and a potassium salt. Specific examples of the lithium salt include lithium carbonate, lithium oxalate, lithium nitrate, lithium sulfate, lithium chloride, lithium acetate, lithium citrate, lithium hydroxide, and an imide salt. Examples of the imide salt include lithium bis(fluorosulfonyl)imide and lithium bis(trifluoromethane sulfonyl)imide. Specific examples of the sodium salt include compounds that include sodium in place of lithium in the above-described specific examples of the lithium salt. Specific examples of the potassium salt include compounds that include potassium in place of lithium in the above-described specific examples of the lithium salt.

The alkaline earth metal salt is not limited to a particular kind, and specific examples thereof include compounds that include an alkaline earth metal element in place of lithium in the above-described lithium salts. Examples of the alkaline earth metal salt include a calcium salt. The transition metal salt is not limited to a particular kind, and specific examples thereof include compounds that include a transition metal element in place of lithium in the above-described lithium salts.

A content of the ionic material, i.e., a concentration (mol/kg) of each of the positive electrode electrolytic solution 15 and the negative electrode electrolytic solution 16, may be set as desired.

A composition (i.e., a kind of the aqueous solvent and a kind of the electrolyte salt) of the positive electrode electrolytic solution 15 and a composition (i.e., a kind of the aqueous solvent and a kind of the electrolyte salt) of the negative electrode electrolytic solution 16 may be the same as or different from each other. However, the negative electrode electrolytic solution 16 has a pH that is higher than the pH of the positive electrode electrolytic solution 15.

A reason why the pH of the negative electrode electrolytic solution 16 is higher than the pH of the positive electrode electrolytic solution 15 is that a decomposition potential of the aqueous solvent shifts owing to the pH difference, as compared with, for example, a case where the pH of the negative electrode electrolytic solution 16 is the same as the pH of the positive electrode electrolytic solution 15. This widens a potential window of the aqueous solvent while thermodynamically suppressing a decomposition reaction of the aqueous solvent upon charging and discharging. Accordingly, the charging and discharging reactions utilizing insertion and extraction of the alkali metal ion proceed sufficiently and stably while a high voltage is obtained.

In particular, it is preferable that the composition (i.e., the kind of the electrolyte salt) of the positive electrode electrolytic solution 15 and the composition (i.e., the kind of the electrolyte salt) of the negative electrode electrolytic solution 16 be different from each other. A reason for this is that this makes it easier to control the pH of the negative electrode electrolytic solution 16 to be higher than the pH of the positive electrode electrolytic solution 15.

The value of the pH of each of the negative electrode electrolytic solution 16 and the positive electrode electrolytic solution 15 is not particularly limited as long as the pH of the negative electrode electrolytic solution 16 is higher than the pH of the positive electrode electrolytic solution 15.

In particular, the pH of the negative electrode electrolytic solution 16 is preferably higher than or equal to 11, more preferably higher than or equal to 12, and still more preferably higher than or equal to 13. A reason for this is that this allows the negative electrode electrolytic solution 16 to have a sufficiently high pH, therefore making it easier for the pH of the negative electrode electrolytic solution 16 to be higher than the pH of the positive electrode electrolytic solution 15. Another reason is that this provides a sufficiently large difference between the pH of the positive electrode electrolytic solution 15 and the pH of the negative electrode electrolytic solution 16, therefore making it easier to maintain the high-and-low relationship between the pHs of the two electrolytic solutions.

The pH of the positive electrode electrolytic solution 15 is preferably within a range from 3 to 8 both inclusive, more preferably within a range from 4 to 8 both inclusive, and still more preferably within a range from 4 to 6 both inclusive. A reason for this is that this provides a sufficiently large difference between the pH of the positive electrode electrolytic solution 15 and the pH of the negative electrode electrolytic solution 16, therefore making it easier to maintain the high-and-low relationship between the pHs of the two electrolytic solutions. Another reason is that this suppresses corrosion of the outer package member 11, and also suppresses corrosion of a battery component member such as the positive electrode current collector 13A or the negative electrode current collector 14A, therefore improving electrochemical durability or stability of the secondary battery.

The electrolyte salt includes an alkali metal salt including, as a cation, the alkali metal ion to be inserted into and extracted from each of the positive electrode 13 and the negative electrode 14. In this case, the electrolyte salt may further include one or more of materials including optional electrolyte salts and a non-electrolyte. Note that the above-described alkali metal salt including the alkali metal ion to be inserted into and extracted from each of the positive electrode 13 and the negative electrode 14 as a cation is excluded from the above-described optional electrolyte salts. Kinds of the optional electrolyte salts (kinds of cations and kinds of anions) are not particularly limited and may be selected as desired.

Here, the positive electrode electrolytic solution 15, the negative electrode electrolytic solution 16, or each of the positive electrode electrolytic solution 15 and the negative electrode electrolytic solution 16 includes the alkali metal salt including the alkali metal ion to be inserted into and extracted from each of the positive electrode 13 and the negative electrode 14 as a cation, as described above. The alkali metal salt is not limited to a particular kind. Therefore, only one kind of alkali metal salt may be used, or two or more kinds of alkali metal salts may be used.

In this case, the positive electrode electrolytic solution 15, the negative electrode electrolytic solution 16, or each of the positive electrode electrolytic solution 15 and the negative electrode electrolytic solution 16 may further include one or more of other metal salts. The other metal salts each include, as a cation, another metal ion different from the alkali metal ion to be inserted into and extracted from each of the positive electrode 13 and the negative electrode 14. The other metal ion may be a metal ion to be inserted into and extracted from each of the positive electrode 13 and the negative electrode 14, may be a metal ion not to be inserted into and extracted from each of the positive electrode 13 and the negative electrode 14, or may be both.

The other metal ion that is the metal ion to be inserted into and extracted from each of the positive electrode 13 and the negative electrode 14 is not limited to a particular kind. Therefore, only one kind of such a metal ion may be used, or two or more kinds of such metal ions may be used. Examples of the other metal ion in this case include an alkali metal ion other than the alkali metal ion to be inserted into and extracted from each of the positive electrode 13 and the negative electrode 14.

The other metal ion that is the metal ion not to be inserted into and extracted from each of the positive electrode 13 and the negative electrode 14 is not limited to a particular kind. Therefore, only one kind of such a metal ion may be used, or two or more kinds of such metal ions may be used. Examples of the other metal ion in this case include one or more of freely-selected metal ions including, without limitation, an alkali metal ion other than the alkali metal ion to be inserted into and extracted from each of the positive electrode 13 and the negative electrode 14, an alkaline earth metal ion, a transition metal ion, and any other metal ion.

More specifically, the positive electrode electrolytic solution 15, the negative electrode electrolytic solution 16, or each of the positive electrode electrolytic solution 15 and the negative electrode electrolytic solution 16 includes a lithium salt including a lithium ion serving as a cation, as the alkali metal salt including the alkali metal ion to be inserted into and extracted from each of the positive electrode 13 and the negative electrode 14 serving as a cation.

In this case, the positive electrode electrolytic solution 15, the negative electrode electrolytic solution 16, or each of the positive electrode electrolytic solution 15 and the negative electrode electrolytic solution 16 preferably further includes one or more of the above-described other metal salts each including the other metal ion serving as a cation. A reason for this is that the combination use of two or more metal salts, i.e., the alkali metal salt and the other metal salt, makes it easier to control each of the pH of the positive electrode electrolytic solution 15 and the pH of the negative electrode electrolytic solution 16, as compared with a case of using only one metal salt, i.e., only the alkali metal salt.

In particular, the positive electrode electrolytic solution 15, the negative electrode electrolytic solution 16, or each of the positive electrode electrolytic solution 15 and the negative electrode electrolytic solution 16 preferably includes: a lithium salt (a lithium ion) which is the alkali metal salt; and a sodium salt (a sodium ion), a potassium salt (a potassium ion), or both which are the other metal salts. A reason for this is that this makes it easier to control the pH of the negative electrode electrolytic solution 16 to be sufficiently higher than the pH of the positive electrode electrolytic solution 15, and therefore makes it easier to maintain the high-and-low relationship between the pHs of the two electrolytic solutions.

Note that the positive electrode electrolytic solution 15, the negative electrode electrolytic solution 16, or each of the positive electrode electrolytic solution 15 and the negative electrode electrolytic solution 16 is preferably a saturated solution of the alkali metal salt including the alkali metal ion to be inserted into and extracted from each of the positive electrode 13 and the negative electrode 14 as a cation. In particular, it is more preferable that each of the positive electrode electrolytic solution 15 and the negative electrode electrolytic solution 16 be the above-described saturated solution of the alkali metal salt. A reason for this is that the charging and discharging reactions, i.e., the insertion and extraction reactions of the alkali metal ion, proceed stably upon charging and discharging.

In order to check whether the positive electrode electrolytic solution 15 is the saturated solution of the electrolyte salt, i.e., the alkali metal salt, the secondary battery may be disassembled, following which whether the electrolyte salt is deposited in an inside of the positive electrode compartment S1 may be checked. Specific examples of the inside of the positive electrode compartment S1 include a location in the positive electrode electrolytic solution 15, a location on a surface of the partition 12, a location on a surface of the positive electrode 13, and a location on an inner wall surface of the outer package member 11. If the electrolyte salt is deposited and the positive electrode electrolytic solution 15, which is a liquid, and the deposited matter of the electrolyte salt, which is a solid, therefore coexist in the inside of the positive electrode compartment S1, it is conceivable that the positive electrode electrolytic solution 15 is a saturated solution of the electrolyte salt. In order to examine a composition of the deposited matter, a surface analysis method such as X-ray photoelectron spectroscopy (XPS) is usable, or a composition analysis method such as the ICP optical emission spectroscopy is usable.

A method of checking whether the negative electrode electrolytic solution 16 is a saturated solution of the electrolyte salt, i.e., the alkali metal salt, is similar to the above-described method of checking whether the positive electrode electrolytic solution 15 is a saturated solution of the electrolyte salt, i.e., the alkali metal salt, except that the negative electrode compartment S2 is checked instead of the positive electrode compartment S1.

Further, the positive electrode electrolytic solution 15 and the negative electrode electrolytic solution 16 may each be a pH buffer solution. The pH buffer solution may be, for example, an aqueous solution in which a weak acid and a conjugate base thereof are mixed together, or an aqueous solution in which a weak base and a conjugate acid thereof are mixed together. A reason for this is that this sufficiently suppresses variation in pH, and therefore makes it easier to maintain each of the pH of the positive electrode electrolytic solution 15 and the pH of the negative electrode electrolytic solution 16 described above.

In particular, the positive electrode electrolytic solution 15 preferably includes one or more of a sulfuric acid ion, a hydrogen sulfuric acid ion, a nitric acid ion, a carbonic acid ion, a hydrogen carbonic acid ion, a phosphoric acid ion, a monohydrogen phosphoric acid ion, a dihydrogen phosphoric acid ion, and a carboxylic acid ion as an anion or anions. A reason for this is that this sufficiently suppresses variation in pH of the positive electrode electrolytic solution 15, therefore making it easier to sufficiently maintain each of the pH of the positive electrode electrolytic solution 15 and the pH of the negative electrode electrolytic solution 16 described above. Examples of the carboxylic acid ion include a formic acid ion, an acetic acid ion, a propionic acid ion, a tartaric acid ion, and a citric acid ion.

Note that the positive electrode electrolytic solution 15 and the negative electrode electrolytic solution 16 may each include one or more of materials including, without limitation, tris(hydroxymethyl)aminomethane and ethylenediaminetetraacetic acid as a buffer or buffers.

More specifically, it is preferable that the positive electrode electrolytic solution 15 include one or more of a sulfuric acid ion, a hydrogen sulfuric acid ion, a nitric acid ion, a carbonic acid ion, a hydrogen carbonic acid ion, a phosphoric acid ion, a monohydrogen phosphoric acid ion, and a dihydrogen phosphoric acid ion as an anion or anions, and the negative electrode electrolytic solution 16 include a hydroxide ion as an anion. A reason for this is that this makes it easier to control the pH of the positive electrode electrolytic solution 15 to be sufficiently low and to control the pH of the negative electrode electrolytic solution 16 to be sufficiently high.

Here, the positive electrode electrolytic solution 15 and the negative electrode electrolytic solution 16 are preferably isotonic solutions that are isotonic with each other. A reason for this is that this makes osmotic pressure of each of the positive electrode electrolytic solution 15 and the negative electrode electrolytic solution 16 appropriate, and therefore makes it easier to maintain the high-and-low relationship between the pHs of the two electrolytic solutions.

Note that the pH of the positive electrode electrolytic solution 15 is preferably so set as to prevent each of the positive electrode current collector 13A and the positive electrode active material layer 13B from being corroded easily. Similarly, the pH of the negative electrode electrolytic solution 16 is preferably so set as to prevent each of the negative electrode current collector 14A and the negative electrode active material layer 14B from being corroded easily. A reason for this is that this makes it easier for the charging and discharging reactions using the positive electrode 13 and the negative electrode 14 to proceed stably and continuously.

Upon charging the secondary battery, when the alkali metal ion is extracted from the positive electrode 13, the extracted alkali metal ion moves through the positive electrode electrolytic solution 15, the partition 12, and the negative electrode electrolytic solution 16 in this order to the negative electrode 14. Thus, the alkali metal ion is inserted into the negative electrode 14.

Upon discharging the secondary battery, when the alkali metal ion is extracted from the negative electrode 14, the extracted alkali metal ion moves through the negative electrode electrolytic solution 16, the partition 12, and the positive electrode electrolytic solution 15 in this order to the positive electrode 13. Thus, the alkali metal ion is inserted into the positive electrode 13.

In a case of manufacturing the secondary battery, the positive electrode 13 and the negative electrode 14 are each fabricated and the positive electrode electrolytic solution 15 and the negative electrode electrolytic solution 16 are each prepared, following which the secondary battery is fabricated, as described below.

First, the positive electrode active material, the positive electrode binder, and the positive electrode conductor are mixed with each other to thereby obtain a positive electrode mixture. Thereafter, the positive electrode mixture is put into the solvent to thereby prepare a paste positive electrode mixture slurry. The solvent may be an aqueous solvent, or may be an organic solvent. Lastly, the positive electrode mixture slurry is applied on the two opposed surfaces of the positive electrode current collector 13A (excluding the coupling terminal part 13AT) to thereby form the positive electrode active material layers 13B. Thereafter, the positive electrode active material layers 13B may be compression-molded by means of, for example, a roll pressing machine. In this case, the positive electrode active material layers 13B may be heated. The positive electrode active material layers 13B may be compression-molded multiple times. In this manner, the positive electrode active material layers 13B are formed on the respective two opposed surfaces of the positive electrode current collector 13A. Thus, the positive electrode 13 is fabricated.

The negative electrode active material layers 14B are formed on the respective two opposed surfaces of the negative electrode current collector 14A by a procedure similar to the procedure for fabricating the positive electrode 13 described above. Specifically, the negative electrode active material, the negative electrode binder, and the negative electrode conductor are mixed with each other to thereby obtain a negative electrode mixture. Thereafter, the negative electrode mixture is put into the solvent to thereby prepare a paste negative electrode mixture slurry. Thereafter, the negative electrode mixture slurry is applied on the two opposed surfaces of the negative electrode current collector 14A (excluding the coupling terminal part 14AT) to thereby form the negative electrode active material layers 14B. Thereafter, the negative electrode active material layers 14B may be compression-molded. In this manner, the negative electrode active material layers 14B are formed on the respective two opposed surfaces of the negative electrode current collector 14A. Thus, the negative electrode 14 is fabricated.

First, the alkali metal salt is put into the aqueous solvent to thereby prepare an aqueous solution in which the alkali metal salt is dissolved in the aqueous solvent. The aqueous solvent is not limited to a particular kind, and specific examples thereof include pure water. The alkali metal salt is a salt including, as a cation, the alkali metal ion to be inserted into and extracted from each of the positive electrode 13 and the negative electrode 14. The alkali metal salt is not limited to a particular kind, and specifically includes one or more of materials including, without limitation, a hydroxide salt and a carbonic acid salt. Examples of the alkali metal salt where the alkali metal ion is a lithium ion include lithium hydroxide and lithium carbonate.

Thereafter, the ion exchange membrane (the cation exchange membrane) is immersed in the aqueous solution to thereby perform a pretreatment on the cation exchange membrane. The cation exchange membrane to be used here includes ion exchange groups (—X⁻H⁺), and is thus a so-called untreated cation exchange membrane. The “untreated cation exchange membrane” is a cation exchange membrane in which the hydrogen ions included in the ion exchange groups are not substituted with the alkali metal ions, and is therefore a cation exchange membrane which is not ion exchanged with the alkali metal ion.

With such a pretreatment, the hydrogen ions included in the ion exchange groups are substituted with the alkali metal ions in the cation exchange membrane. The cation exchange membrane is thus ion exchanged with the alkali metal ion. Accordingly, the cation exchange membrane including the ion exchange groups (—X⁻M⁺) is obtained.

Lastly, the cation exchange membrane subjected to the pretreatment is taken out from the aqueous solution, following which the cation exchange membrane is dried. Thus, the partition 12 serving as the cation exchange membrane that is ion exchanged in advance with the alkali metal ion is fabricated.

The ionic material is added to the aqueous solvent to thereby prepare each of the positive electrode electrolytic solution 15 and the negative electrode electrolytic solution 16. In this case, conditions including, without limitation, a kind and a concentration (mol/kg) of the ionic material are adjusted to thereby allow the pH of the negative electrode electrolytic solution 16 to be higher than the pH of the positive electrode electrolytic solution 15.

First, the positive electrode 13 is attached to the outer package part 11X, and the negative electrode 14 is attached to the outer package part 11Y. In this case, the positive electrode 13 is placed inside the outer package part 11X, and the coupling terminal part 13AT is led out of the outer package part 11X. Further, the negative electrode 14 is placed inside the outer package part 11Y, and the coupling terminal part 14AT is led out of the outer package part 11Y.

Thereafter, the outer package parts 11X and 11Y are disposed in such a manner as to be opposed to each other with the partition 12 interposed therebetween, following which the outer package parts 11X and 11Y are joined to each other with the partition 12 interposed therebetween with use of a material such as an adhesive. The outer package member 11 is thus assembled. As a result, the internal space of the outer package member 11 is divided into two spaces by the partition 12, and the positive electrode compartment S1 and the negative electrode compartment S2 are thus formed.

Lastly, the positive electrode electrolytic solution 15 is supplied into the positive electrode compartment S1 through an unillustrated positive electrode injection hole that is in communication with the positive electrode compartment S1, and the negative electrode electrolytic solution 16 is supplied into the negative electrode compartment S2 through an unillustrated negative electrode injection hole that is in communication with the negative electrode compartment S2. Thereafter, the positive electrode injection hole and the negative electrode injection hole are each sealed.

Thus, the positive electrode electrolytic solution 15 is contained in the positive electrode compartment S1 in which the positive electrode 13 is disposed, and the negative electrode electrolytic solution 16 is contained in the negative electrode compartment S2 in which the negative electrode 14 is disposed. As a result, the secondary battery including two aqueous electrolytic solutions (i.e., the positive electrode electrolytic solution 15 and the negative electrode electrolytic solution 16) is completed.

According to the secondary battery, the positive electrode compartment S1 has the positive electrode 13 disposed therein and contains the positive electrode electrolytic solution 15 which is the aqueous electrolytic solution, the negative electrode compartment S2 has the negative electrode 14 disposed therein and contains the negative electrode electrolytic solution 16 which is the aqueous electrolytic solution, and the partition 12 that allows the alkali metal ion to pass therethrough is disposed between the positive electrode compartment S1 and the negative electrode compartment S2. Further, the negative electrode electrolytic solution 16 has the pH that is higher than the pH of the positive electrode electrolytic solution 15, and the partition 12 includes the cation exchange membrane that is ion exchanged with the alkali metal ion.

In this case, the partition 12 includes the cation exchange membrane, and this makes it easier for each of the aqueous solvent in the positive electrode electrolytic solution 15 and the aqueous solvent in the negative electrode electrolytic solution 16 to permeate into the partition 12 as described above. This improves the ion conductive property inside the partition 12, which makes it easier for the alkali metal ion to move between the positive electrode 13 and the negative electrode 14 via the partition 12.

Further, the pH of the negative electrode electrolytic solution 16 is higher than the pH of the positive electrode electrolytic solution 15, which allows the decomposition potential of the aqueous solvent to shift as described above. This widens the potential window of the aqueous solvent while thermodynamically suppressing the decomposition reaction of the aqueous solvent upon charging and discharging. Accordingly, the charging and discharging reactions utilizing insertion and extraction of the alkali metal ion proceed sufficiently and stably while a high voltage is obtained.

In addition, the cation exchange membrane is ion exchanged in advance with the alkali metal ion, which prevents the respective pHs of the positive electrode electrolytic solution 15 and the negative electrode electrolytic solution 16 from varying easily. This makes it easier to maintain the high-and-low relationship between the pH of the positive electrode electrolytic solution 15 and the pH of the negative electrode electrolytic solution 16. As a result, the electrode component material such as the positive electrode active material or the negative electrode active material is prevented from degrading easily, and the electrode component member such as the positive electrode current collector 13A or the negative electrode current collector 14A is prevented from corroding easily.

Based upon the foregoing, even if the two aqueous electrolytic solutions (i.e., the positive electrode electrolytic solution 15 and the negative electrode electrolytic solution 16) are used, a high voltage is obtained and the charging and discharging reactions proceed sufficiently and stably while the degradation of the electrode component material and the corrosion of the electrode component member are each suppressed. Thus, a discharge capacity is prevented from decreasing easily even if charging and discharging are repeated. Accordingly, it is possible to achieve a superior cyclability characteristic.

In particular, the partition 12 may include the upper end part 12A that is in contact with neither the positive electrode electrolytic solution 15 nor the negative electrode electrolytic solution 16, and the upper end part 12A may include the cation exchange membrane that is ion exchanged with the alkali metal. This makes it possible to check afterward, even with the used secondary battery, whether the cation exchange membrane is ion exchanged in advance with the alkali metal ion. Thus, using the cation exchange membrane that is ion exchanged in advance with the alkali metal ion as the partition 12 makes it possible to achieve easily and stably the secondary battery having a superior cyclability characteristic. Accordingly, it is possible to achieve higher effects.

The advantage related to the case where the partition 12 includes the upper end part 12A described here is similarly obtained also in the case where the partition 12 includes the lower end part 12C.

Further, the pH of the positive electrode electrolytic solution 15 may be within a range from 3 to 8 both inclusive, and the pH of the negative electrode electrolytic solution 16 may be higher than or equal to 11. This makes it easier to maintain the high-and-low relationship between the pH of the positive electrode electrolytic solution 15 and the pH of the negative electrode electrolytic solution 16. Accordingly, it is possible to achieve higher effects.

Further, the positive electrode electrolytic solution 15, the negative electrode electrolytic solution 16, or each of the positive electrode electrolytic solution 15 and the negative electrode electrolytic solution 16 may be the saturated solution of the alkali metal salt. This allows the charging and discharging reactions, i.e., the insertion and extraction reactions of the alkali metal ion, to proceed stably upon charging and discharging. Accordingly, it is possible to achieve higher effects.

Further, the metal ion to be inserted into and extracted from each of the positive electrode 13 and the negative electrode 14 may be the alkali metal ion. This secures mobility of the alkali metal ion. Accordingly, it is possible to achieve higher effects.

The configuration of the secondary battery is appropriately modifiable including as described below according to an embodiment. Note that any two or more of the following series of modifications may be combined with each other.

In FIG. 1, for example, the outer package member 11 includes the outer package parts 11X and 11Y, and the outer package parts 11X and 11Y are joined to each other with the partition 12 interposed therebetween. Thus, each of the upper end part 12A and the lower end part 12C is exposed to the outside of the outer package member 11. However, a configuration of the outer package member 11 is not particularly limited as long as the outer package member 11 is able to hold the partition 12.

Specifically, as illustrated in FIG. 2 corresponding to FIG. 1, each of the upper end part 12A and the lower end part 12C may not necessarily be exposed to the outside of the outer package member 11. A configuration of a secondary battery illustrated in FIG. 2 is similar to the configuration of the secondary battery illustrated in FIG. 1 except for those described below.

Here, the outer package member 11 is one member having an internal space, and a pair of depressions 11M and 11N is provided on the inner wall surface of the outer package member 11. The depressions 11M and 11N are disposed at respective positions opposed to each other with the internal space therebetween. The upper end part 12A is disposed in the depression 11M, and the lower end part 12C is disposed in the depression 11N. As a result, the partition 12 is held by the outer package member 11, and the positive electrode compartment S1 and the negative electrode compartment S2 are separated from each other with the partition 12 interposed therebetween.

In this case also, the outer package member 11 holds the partition 12 and the alkali metal ion is allowed to pass through the partition 12. Accordingly, it is possible to achieve effects similar to those of the case illustrated in FIG. 1. Needless to say, because the partition 12 includes the upper end part 12A and the lower end part 12C, it is also possible to check afterward whether the cation exchange membrane serving as the partition 12 is ion exchanged in advance with the alkali metal ion for the reason described above.

Although not specifically illustrated here, in FIG. 2, the outer package member 11 may include only one of the depression 11M or the depression 11N, and the partition 12 may thus include only one of the upper end part 12A or the lower end part 12C. In this case also, similar effects are achievable if the outer package member 11 is able to hold the partition 12 and the partition 12 is able to separate the positive electrode electrolytic solution 15 and the negative electrode electrolytic solution 16 from each other.

In FIG. 1, the electrolytic solutions which are liquid electrolytes, i.e., the positive electrode electrolytic solution 15 and the negative electrode electrolytic solution 16, are used.

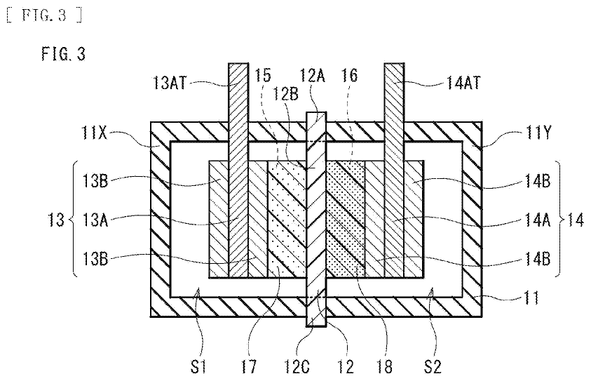

However, as illustrated in FIG. 3 corresponding to FIG. 1, electrolyte layers 17 and 18 may be used instead of the electrolytic solutions. The electrolyte layers 17 and 18 are gel electrolytes. A configuration of a secondary battery illustrated in FIG. 3 is similar to the configuration of the secondary battery illustrated in FIG. 1 except for those described below.

Here, the electrolyte layer 17 is interposed between the partition 12 and the positive electrode 13, and the electrolyte layer 18 is interposed between the partition 12 and the negative electrode 14. In other words, the electrolyte layer 17 is adjacent to each of the partition 12 and the positive electrode 13, and the electrolyte layer 18 is adjacent to each of the partition 12 and the negative electrode 14.

Specifically, the electrolyte layer 17 includes the positive electrode electrolytic solution 15 and a polymer compound, and the positive electrode electrolytic solution 15 is held by the polymer compound. The electrolyte layer 18 includes the negative electrode electrolytic solution 16 and a polymer compound, and the negative electrode electrolytic solution 16 is held by the polymer compound. The polymer compound is not limited to a particular kind, and specifically includes one or more of materials including, without limitation, polyvinylidene difluoride and polyethylene oxide. In FIG. 3, the electrolyte layer 17 including the positive electrode electrolytic solution 15 is lightly shaded and the electrolyte layer 18 including the negative electrode electrolytic solution 16 is darkly shaded.

In a case of forming the electrolyte layer 17, the positive electrode electrolytic solution 15, the polymer compound, and a solvent are mixed with each other to thereby prepare a precursor solution in a sol form, following which the precursor solution is applied on the surface of the positive electrode 13. In a case of forming the electrolyte layer 18, the negative electrode electrolytic solution 16, the polymer compound, and a solvent are mixed with each other to thereby prepare a precursor solution in a sol form, following which the precursor solution is applied on the surface of the negative electrode 14.

In this case also, the alkali metal ion is movable between the positive electrode 13 and the negative electrode 14 via the electrolyte layers 17 and 18. Accordingly, it is possible to achieve effects similar to those of the case illustrated in FIG. 1.

Although not specifically illustrated here, in FIG. 3, the secondary battery may include only one of the electrolyte layer 17 or the electrolyte layer 18. In other words, the electrolyte layer 18 may be used together with the positive electrode electrolytic solution 15, or the negative electrode electrolytic solution 16 may be used together with the electrolyte layer 17. In this case also, similar effects are achievable.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

Needless to say, the secondary battery may have applications other than the series of applications described here as examples.

### EXAMPLES

Examples of the present technology are described below.

### Examples 1 to 3

As described below, secondary batteries using the lithium ion which is the alkali metal ion as the metal ion to be inserted and extracted were manufactured, following which the secondary batteries were each evaluated for a battery characteristic.

### [Manufacturing of Secondary Battery]

The secondary batteries illustrated in FIG. 1 were manufactured in accordance with the following procedure.

### (Fabrication of Partition)

First, the alkali metal salt (lithium hydroxide) was put into the aqueous solvent (pure water) in a container, following which the aqueous solvent was stirred to thereby prepare the aqueous solution having a concentration of 1 mol/kg.

Thereafter, the ion exchange membrane (the cation exchange membrane) was immersed in the aqueous solution in the container for an immersion time of 1 hour to thereby perform the pretreatment on the ion exchange membrane. Used as the cation exchange membrane were two Nafion (registered trademark) membranes each including a perfluorocarbon material (a copolymer of tetrafluoroethylene and perfluoro[2-(fluorosulfonylethoxy)propyl vinyl ether]) available from Sigma-Aldrich. The two Nafion membranes are Nafion 115 (type A) and Nafion NRE-212 (type B), and each include ion exchange groups (—S(═O)₂—O⁻H⁺).

Lastly, the cation exchange membrane was taken out from the container (the aqueous solution), following which dry air was blown on a surface of the cation exchange membrane to dry the cation exchange. The cation exchange membrane was thereby ion exchanged with the lithium ion. Thus, the partition 12 (including the upper end part 12A, the intermediate part 12B, and the lower end part 12C) was fabricated.

After the partition 12 was fabricated, the upper end part 12A and the lower end part 12C were each analyzed by the ICP optical emission spectroscopy to confirm that, in each of the upper end part 12A and the lower end part 12C, the cation exchange membrane included the ion exchange groups (—S(═O)₂—O⁻Li⁺). In other words, it was confirmed that the cation exchange membrane was ion exchanged in advance with the lithium ion.

### (Fabrication of Positive Electrode)

First, 91 parts by mass of the positive electrode active material (LiFePO₄ (LFP) which is the lithium phosphoric acid compound), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into the solvent (N-methyl-2-pyrrolidone which is the organic solvent), following which the organic solvent was stirred to thereby prepare a paste positive electrode mixture slurry. Lastly, the positive electrode mixture slurry was applied on the two opposed surfaces of the positive electrode current collector 13A (a titanium (Ti) foil having a thickness of 10 μm) excluding the coupling terminal part 13AT by means of a coating apparatus, following which the applied positive electrode mixture slurry was dried to thereby form the positive electrode active material layers 13B. Thus, the positive electrode 13 was fabricated.

### (Fabrication of Negative Electrode)

First, 89 parts by mass of the negative electrode active material (TiO₂ which is the titanium-containing compound), 10 parts by mass of the negative electrode binder (polyvinylidene difluoride), and 1 part by mass of the negative electrode conductor (graphite) were mixed with each other to thereby obtain a negative electrode mixture. Thereafter, the negative electrode mixture was put into the solvent (N-methyl-2-pyrrolidone which is the organic solvent), following which the organic solvent was stirred to thereby prepare a paste negative electrode mixture slurry. Lastly, the negative electrode mixture slurry was applied on the two opposed surfaces of the negative electrode current collector 14A (a titanium foil having a thickness of 10 μm) excluding the coupling terminal part 14AT by means of a coating apparatus, following which the applied negative electrode mixture slurry was dried to thereby form the negative electrode active material layers 14B. Thus, the negative electrode 14 was fabricated.

### (Preparation of Positive Electrode Electrolytic Solution)

The ionic material was put into the aqueous solvent (pure water), following which the aqueous solvent was stirred. The ionic material was thereby dispersed or dissolved in the aqueous solvent. As a result, the positive electrode electrolytic solution 15 which is the aqueous electrolytic solution was prepared. The kind of the ionic material, and the concentration (mol/kg) and the pH of the positive electrode electrolytic solution 15 were as listed in Table 1. The description with parentheses “(sat)” in the column of the “concentration” in Table 1 represents that the positive electrode electrolytic solution 15 was a saturated solution. Used as the ionic material were lithium sulfate (Li₂SO₄) and lithium nitrate (LiNO₃) which are each the electrolyte salt (the lithium salt).

### (Preparation of Negative Electrode Electrolytic Solution)

The negative electrode electrolytic solution 16 which is the aqueous electrolytic solution was prepared by a procedure similar to the procedure for preparing the positive electrode electrolytic solution 15. The kind of the ionic material, and the concentration (mol/kg) and the pH of the negative electrode electrolytic solution 16 were as listed in Table 1. Used as the ionic material was lithium hydroxide (LiOH) which is the electrolyte salt (the lithium salt).

### (Assembly of Secondary Battery)

First, the outer package parts 11X and 11Y that were each a glass containers were disposed in such a manner as to be opposed to each other with the partition 12 interposed therebetween, following which the outer package parts 11X and 11Y were adhered to each other with the partition 12 interposed therebetween with use of an adhesive. Thus, the outer package member 11 (a glass case) including the positive electrode compartment S1 and the negative electrode compartment S2 therein was formed.

Thereafter, the positive electrode 13 was placed into the positive electrode compartment S1, and the negative electrode 14 was placed into the negative electrode compartment S2. In this case, the coupling terminal parts 13AT and 14AT were each led out of the outer package member 11.

Lastly, the positive electrode electrolytic solution 15 was supplied into the positive electrode compartment S1, and the negative electrode electrolytic solution 16 was supplied into the negative electrode compartment S2. Thus, the positive electrode electrolytic solution 15 was contained in the positive electrode compartment S1 in which the positive electrode 13 was disposed, and the negative electrode electrolytic solution 16 was contained in the negative electrode compartment S2 in which the negative electrode 14 was disposed. As a result, the secondary battery including two aqueous electrolytic solutions (i.e., the positive electrode electrolytic solution 15 and the negative electrode electrolytic solution 16) was completed.

### Comparative Examples 1 to 5

The secondary batteries were manufactured by a similar procedure except that the cation exchange membrane was not subjected to the pretreatment and therefore included the ion exchange groups (—S(═O)₂—O⁻H⁺), and that such a cation exchange membrane was used as it was as the partition 12. Thereafter, the secondary batteries were each evaluated for a battery characteristic.

Further, the secondary batteries were manufactured by a similar procedure except that the positive electrode electrolytic solution 15 was changed in composition, and were each thereafter evaluated for a battery characteristic. The kind of the ionic material, and the concentration (mol/kg) and the pH of the positive electrode electrolytic solution 15 were as listed in Table 1.

### [Evaluation of Battery Characteristic]

The secondary batteries were each evaluated for a cyclability characteristic as a battery characteristic. The evaluation results are presented in Table 1.

In a case of examining the cyclability characteristic, first, the secondary battery was charged and discharged in an ambient temperature environment (at a temperature of 25° C.) to thereby measure a discharge capacity (a first-cycle discharge capacity). Thereafter, the secondary battery was repeatedly charged and discharged until the number of cycles (the number of times of charging and discharging) reached 20 to thereby measure the discharge capacity (a 20th-cycle discharge capacity). Lastly, a capacity retention rate which is an index for evaluating the cyclability characteristic was calculated on the basis of the following calculation expression: capacity retention rate (%)=(20th-cycle discharge capacity/first-cycle discharge capacity)×100.

Upon charging, the secondary battery was charged with a constant current of 2 C until a voltage reached 1.7 V, and was thereafter discharged with a constant current of 2 C until the voltage reached 1.2 V. Note that 2 C is a value of a current that causes a battery capacity (a theoretical capacity) to be completely discharged in 0.5 hours.

TABLE 1

| | Positive electrode | | | Negative electrode | | | | | Capacity |
|---|---|---|---|---|---|---|---|---|---|
| | electrolytic solution | | | electrolytic solution | | | Partition | | retention |
| | Ionic | Concentration | | Ionic | Concentration | | Ion exchange | Ion exchange | rate |
| | material | (mol/kg) | pH | material | (mol/kg) | pH | membrane | (pretreatment) | (%) |
| Example 1 | Li₂SO₄ | 3 (sat) | 5 | LiOH | 4 (sat) | 12 | Type A | Yes | 95 |
| Example 2 | LiNO₃ | 13 (sat) | 4 | LiOH | 4 (sat) | 12 | Type A | Yes | 87 |
| Example 3 | LiNO₃ | 13 (sat) | 4 | LiOH | 4 (sat) | 12 | Type B | Yes | 89 |
| Comparative example 1 | Li₂SO₄ | 3 (sat) | 5 | LiOH | 4 (sat) | 12 | Type A | No | 20 |
| Comparative example 2 | LiNO₃ | 13 (sat) | 4 | LiOH | 4 (sat) | 12 | Type A | No | 21 |
| Comparative example 3 | LiNO₃ | 13 (sat) | 4 | LiOH | 4 (sat) | 12 | Type B | No | 21 |
| Comparative example 4 | LiOH | 4 (sat) | 12 | LiOH | 4 (sat) | 12 | Type A | Yes | <10 |
| Comparative example 5 | LiOH | 4 (sat) | 12 | LiOH | 4 (sat) | 12 | Type A | No | <10 |

As indicated in Table 1, the capacity retention rate varied depending on the configuration of the partition 12, and a physical property (i.e., the pH) of each of the positive electrode electrolytic solution 15 and the negative electrode electrolytic solution 16.

Specifically, in a case where the pH of the negative electrode electrolytic solution 16 was higher than the pH of the positive electrode electrolytic solution 15, but where the partition 12 included the cation exchange membrane that was not ion exchanged, i.e., not subjected to the pretreatment (Comparative examples 1 to 3), the capacity retention rate decreased. Further, in a case where the partition 12 included the cation exchange membrane that was ion exchanged, but where the pH of the negative electrode electrolytic solution 16 was equal to the pH of the positive electrode electrolytic solution 15 (Comparative example 4), the capacity retention rate decreased markedly. Note that, in a case where the pH of the negative electrode electrolytic solution 16 was equal to the pH of the positive electrode electrolytic solution 15, and where the partition 12 included the cation exchange membrane that was not ion exchanged (Comparative example 5), the capacity retention rate also decreased markedly.

In contrast, in a case where the partition 12 included the cation exchange membrane that was ion exchanged, and where the pH of the negative electrode electrolytic solution 16 was higher than the pH of the positive electrode electrolytic solution 15 (Examples 1 to 3), the capacity retention rate increased markedly.

In this case, a sufficiently high capacity retention rate was achieved in a case where the pH of the positive electrode electrolytic solution 15 was within a range from 3 to 8 both inclusive and the pH of the negative electrode electrolytic solution 16 was higher than or equal to 11, in particular. Further, in a case where each of the positive electrode electrolytic solution 15 and the negative electrode electrolytic solution 16 was a saturated solution, a sufficiently high capacity retention rate was achieved.

Based upon the results presented in Table 1, the capacity retention rate increased in a case where, in the secondary battery including two aqueous electrolytic solutions (i.e., the positive electrode electrolytic solution 15 and the negative electrode electrolytic solution 16): the partition 12 included the cation exchange membrane that was ion exchanged with the alkali metal ion; and the negative electrode electrolytic solution 16 had the pH that was higher than the pH of the positive electrode electrolytic solution 15. The secondary battery therefore achieved a superior cyclability characteristic.

Although the configuration of the secondary battery of the present technology has been described above with reference to one or more embodiments including Examples, the configuration of the secondary battery of the technology is not limited thereto, and is therefore modifiable in a variety of suitable ways.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a partition that is disposed between a positive electrode space and a negative electrode space, thereby allowing a metal ion to pass therethrough;
a positive electrode that is disposed in the positive electrode space and which the metal ion is to be inserted into and extracted from;
a negative electrode that is disposed in the negative electrode space and which the metal ion is to be inserted into and extracted from;
a positive electrode electrolytic solution that is contained in the positive electrode space and includes an aqueous solvent; and
a negative electrode electrolytic solution that is contained in the negative electrode space and includes an aqueous solvent, the negative electrode electrolytic solution having a pH that is higher than a pH of the positive electrode electrolytic solution, wherein
the partition includes a cation exchange membrane that is ion exchanged with the metal ion.

2. The secondary battery according to claim 1, wherein
the partition includes
a contact part that is provided between the positive electrode space and the negative electrode space, and is in contact with each of the positive electrode electrolytic solution and the negative electrode electrolytic solution, and
a non-contact part that is not provided between the positive electrode space and the negative electrode space, and is not in contact with the positive electrode electrolytic solution and the negative electrode electrolytic solution, and
the non-contact part includes the cation exchange membrane.

3. The secondary battery according to claim 1, wherein
the pH of the positive electrode electrolytic solution is higher than or equal to 3 and lower than or equal to 8, and
the pH of the negative electrode electrolytic solution is higher than or equal to 11.

4. The secondary battery according to claim 1, wherein
the positive electrode electrolytic solution and the negative electrode electrolytic solution each include a metal salt including the metal ion as a cation, and
one or both of the positive electrode electrolytic solution and the negative electrode electrolytic solution is a saturated solution of the metal salt.

5. The secondary battery according to claim 1, wherein the metal ion comprises an alkali metal ion.
